(19) United States
(12) Patent Application Publication
(10) Pub. No.: US 2008/0112761 A1
(43) Pub. Date: May 15, 2008

(54) IN SITU REMEDIATION OF SOURCE ZONES VIA IN SITU ADMIXING OF CONTAMINATED MEDIA, CHEMICAL OXIDANTS, AND STABILIZING AGENTS

(75) Inventors: Thomas Clay Sale, Ft. Collins, CO (US); David M. Gilbert, Livermore, CO (US)

Correspondence Address: SWANSON & BRATSCHUN, L.L.C., 8210 SOUTHPARK TERRACE, LITTLETON, CO, 80120, US

(73) Assignee: COLORADO STATE UNIVERSITY RESEARCH FOUNDATION, Fort Collins, CO (US)

(21) Appl. No.: 11/737,599

(22) Filed: Apr. 19, 2007

Related U.S. Application Data
(60) Provisional application No. 60/793,398, filed on Apr. 19, 2006.

(51) Int. Cl. B09C 1/08

(52) U.S. Cl. 405/128.5

(57) ABSTRACT

A process for treating contaminants present in subsurface source zones comprises in situ admixing of contaminated media, chemical oxidants and stabilizing agents using known soil-mixing techniques. A grout for treating contaminants present in soil comprises chemical oxidants and stabilizing agents.

### PRIORITY INFORMATION

This application claims priority to U.S. provisional application Ser. No. 60/793,398 entitled “Subsurface Source Remediation Using In-Situ Soil Mixing, Chemical Oxidants and Stabilizing Agents,” filed Apr. 19, 2006, Sale and Gilbert, the entire disclosure of which is hereby incorporated by reference.

### FIELD OF THE INVENTION

The present invention relates generally to the field of environmental engineering. More specifically, the present invention is directed toward the field of the remediation of pollutants in contaminated soil.

### BACKGROUND OF THE INVENTION

A primary environmental challenge of the new millennium is managing a legacy of anthropogenic activities that have produced subsurface source zones, which act as long-term sources of groundwater, surface water, and/or soil gas contamination. Defined by the National Research Council in “Contaminants in the Subsurface: Source Zone Assessment and Remediation” (National Academy of Sciences, 2004, Washington, D.C.) a source zone is “a saturated or unsaturated subsurface zone containing hazardous substances, pollutants, or contaminants that acts as a reservoir that sustains a contaminant plume in groundwater, surface water, or air or acts as a source for direct exposure. This volume may have been in contact with separate phase contaminant (nonaqueous phase liquid [NAPL] or solid). Source zone mass can include sorbed and aqueous-phase contaminants as well as contaminants that exist as a solid or NAPL.”

A primary constraint affecting efficacy of source zone cleanup is subsurface spatial variations in permeability and porosity (referred to as heterogeneity). One manifestation of heterogeneity is that contaminants (occurring as nonaqueous, solid, sorbed, or dissolved phases) are often sparsely distributed as illustrated in FIG. 1A. As a result, locating regions within source zones that require treatment is difficult (often like trying to find a needle in a haystack). Furthermore, remedial agents (including, but not limited to: chemical oxidants, chemical reductants, surfactants, co-solvents, biological amendments, or heat) must be delivered in sufficient amounts to address locally high concentrations of contaminants. Often an inability to deliver a sufficient amount of remedial agent to locally high concentration contaminant intervals, results in a significant fraction of the contaminant mass remaining untreated.

Another manifestation of heterogeneity is the flow of remedial agents along preferential (high permeability) flow paths. In many source zones, the contaminants reside in low permeability layers leading to remedial agent bypass. Thus heterogeneity leads to the occurrences of remedial agent bypass, in addition to insufficient remedial agent delivery, ultimately resulting in untreated contaminant mass.

Challenges associated with heterogeneity can be addressed by employing soil-mixing techniques including, but not limited to, soil augers with grout delivery systems and conventional excavation equipment, which are illustrated in FIGS. 2A and 2B. The purpose of the grout is to deliver a combination of reactive media and stabilizing agents and to facilitate drilling. The stabilizing agents reduce contaminant discharge from the source, provide extended periods for in-situ oxidation to occur, and limit the inflow of naturally occurring oxidizing or reducing agents that might interfere with the desired reactions. In addition, stabilizing agents facilitate drilling and the delivery of remedial agents.

Laboratory studies involving admixing reactive media (post-steam flushing) are described by Day and Moos. Consideration was given to aqueous permanganate solutions, zero valent iron filings, humic acid (adsorbant), DARAMEND® (proprietary biological amendment) and a formate solution (biological amendment). It was found that only iron provided significant additional remediation post-steam flushing. (Day and Moos (1998) “A Comparison of In Situ Soil Mixing Treatments”, Proceeding of the Battelle Remediation of Chlorinated and Recalcitrant Compounds Conference, Monterey, Calif., May 18-21 vol. 1, pages 19-24 (1998)). This work illustrates the ineffectiveness of these biological processes (DARAMEND® and formate). Ultimately steam flushing and iron were used in a full-scale application for a chlorinated solvent source zone at Argonne National Laboratory, Chicago, Ill.

Batchelor et al. describe a method of treating subsurface zone contaminants comprised of admixing reductive metal and stabilizing agents. (Batchelor et al. (1998) U.S. Pat. No. 5,789,649 (1998); Batchelor et al. (2002) U.S. Pat. No. 6,492,572 B2). Batchelor et al. teach metal initiated chemical degradation by which degradation of halogenated organic compounds through chemical means involves the reductive dehalogenation of the contaminant in the presence of a reductive, zero valent metal. These methods are limited in their applicability to contaminants degraded through reductive chemistry.

A method for source treatment of contaminants involving soil mixing is also described by West and Siegrist. In this case contaminants were depleted by air stripping followed by ex situ treatment (Siegrist et al. (1995) Environmental Science & Technology 29(9):2198-2207; West et al. (1995) Environmental Science & Technology 29(9):2191-2197). The use of ex situ treatment is limited by both the effectiveness of the treatment and the cost associated with remediation of a contaminated site.

The use of a chemical oxidant (potassium permanganate) in conjunction with soil mixing is described in USEPA (1998) “Field Applications of In Situ Remediation Technologies: Chemical Oxidation” EPA-542-R-98-008. In addition, elements of a related larger study addressed bioaugmentation and vapor stripping. Reported results indicate approximately 30 and 60 percent of the initial contaminant mass remained in place following treatment with potassium permanganate and bioaugmentation, respectively. This work demonstrated the limited effectiveness of chemical oxidants.

Finally, hot air injection followed by iron addition without stabilizing agents is currently being evaluated through field studies at a chlorinated solvent spill site at Cape Canaveral, Fla.

The above discussion illustrates that the principal challenges associated with managing subsurface source zones are the limited efficacy, limited applicability and enormous expense of proven technologies. The prior art has demonstrated the limited efficacy of chemical oxidants. The prior art has also demonstrated the limited efficacy of stabilizing agents. Soil mixing techniques have been employed with regard to the delivery of chemical oxidants and the delivery of stabilizing agents—both with limited efficacy.

The present invention overcomes these noted limitations, providing an improved process wherein the method comprises admixing chemical oxidants and stabilizing agents with source materials, employing in situ soil-mixing techniques. The use of a combination of stabilizing agents and chemical oxidants will greatly increase the efficacy of the soil remediation.

A second advantage of the invention is the cost effectiveness. Soil mixing is often the lowest cost approach to effective reagent delivery. Additionally, in many instances the lowest cost remedial agents are chemical oxidants including, but not limited to, permanganate, persulfate, ozone and peroxide. By combining the attributes of contaminant mass depletion through chemical oxidation, the addition of stabilizing agents, and the utilization of soil mixing, this technology effectively achieves multiple remedial benefits. The overall anticipated benefit is a substantive reduction in contaminant discharge from treated soils into the surrounding groundwater.

### SUMMARY OF THE INVENTION

The present invention discloses a method for soil remediation comprising admixing a chemical oxidant, a stabilizing agent, and employing in situ soil mixing; wherein the contaminants in the soil in the treated area are diminished. Chemical oxidants may include, but are not limited to, permanganate, persulfate, ozone and peroxide. Stabilizing agents may include clay, but are not limited to, cement, biopolymer and fly ash. In situ soil mixing may include, but is not limited to, shallow soil mixing, deep soil mixing, jet grouting, and mixing with conventional excavation equipment. Contaminants in the soil include, but are not limited to, petroleum hydrocarbons, volatile organic compounds, volatile organic halogenated compounds, semi-volatile organic compounds, semi-volatile organic halogenated compounds, non-volatile organic compounds, pesticides, herbicides, metals, radionuclides, explosives, and emerging contaminants. The in situ the soil mixing is intended to uniformly deliver the chemical oxidants. The stabilizing agent reduces contaminant discharge from the treated area. Further, the stabilizing agent reduces inflow of naturally occurring oxidizing or reducing agents into the treated area. Further provided is a method where the chemical oxidant is persulfate and the stabilizing agent is clay and the treated area is adjacent to a water source, such as a river.

Further provided is a method for treating contaminants present in subsurface source zones comprising in situ soil mixing comprising admixing a chemical oxidant, a stabilizing agent and source materials, wherein the chemical oxidant is selected from the group consisting of permanganate, persulfate, ozone and peroxide; the stabilizing agent is selected from the group consisting of clay, cement, biopolymer and fly ash; and the in situ soil mixing is selected from the group consisting of shallow soil mixing, deep soil mixing, jet grouting, and mixing with conventional excavation equipment. The source materials are selected from the group consisting of petroleum hydrocarbons, volatile organic compounds, volatile organic halogenated compounds, semi-volatile organic compounds, semi-volatile organic halogenated compounds, non-volatile organic compounds, pesticides, herbicides, metals, radionuclides, explosives, and emerging contaminants. The in situ soil mixing may stabilize the nonaqueous phase liquids through the formation of emulsions. The in situ soil mixing is intended to uniformly deliver the chemical oxidants. The stabilizing agent reduces contaminant discharge from the source materials. The stabilizing agent may also reduce inflow of naturally occurring oxidizing or reducing agents.

### BRIEF DESCRIPTION OF THE DRAWINGS

FIG. 1A illustrates a subsurface source zone (Kueper et al. (1993) Ground Water 31:756-766).

FIG. 1B illustrates the concept of admixing reactive media and stabilizing agents for hydrocarbons.

FIGS. 2A and 2B illustrate conventional equipment such as soil augers with fluid delivery systems (FIG. 2A) and conventional excavation equipment (FIG. 2B) that can be used with the method of this invention.

FIG. 3 is a process flow diagram illustrating the homogenization of source zones via soil mixing resulting in a uniform mix of sediments, contaminants, reactive media, and stabilizing agents.

FIG. 4 illustrates the laboratory soils mixing equipment and treated soil columns.

FIG. 5 is a graph illustrating the results from laboratory treatability studies using a variety of oxidants (ORC—Oxygen Release Compound; nutr—nutrients; innoc—innoculum).

FIG. 6 illustrates the design of the field-scale treatability study.

FIG. 7 illustrates the field-scale soil mixing.

FIG. 8 is a table setting forth various grout compositions used in the field-scale treatability study illustrated in FIG. 6.

FIG. 9 is a bar graph illustrating the soil concentrations of the columns of FIG. 6 using the grout compositions of FIG. 8 four months after treatment.

FIG. 10 is a graph of the concentrations of total benzene, toluene, ethyl benzene, and xylenes at the Suncor refinery over one year.

FIG. 11 is a bar graph illustrating the concentrations of identified polyaromatic hydrocarbons at (PAHs) at the Suncor refinery over one year.

FIG. 12 is a schematic representation of in situ deep soil mixing with clay and persulfate.

FIG. 13 illustrates the process steps of the persulfate-clay application.

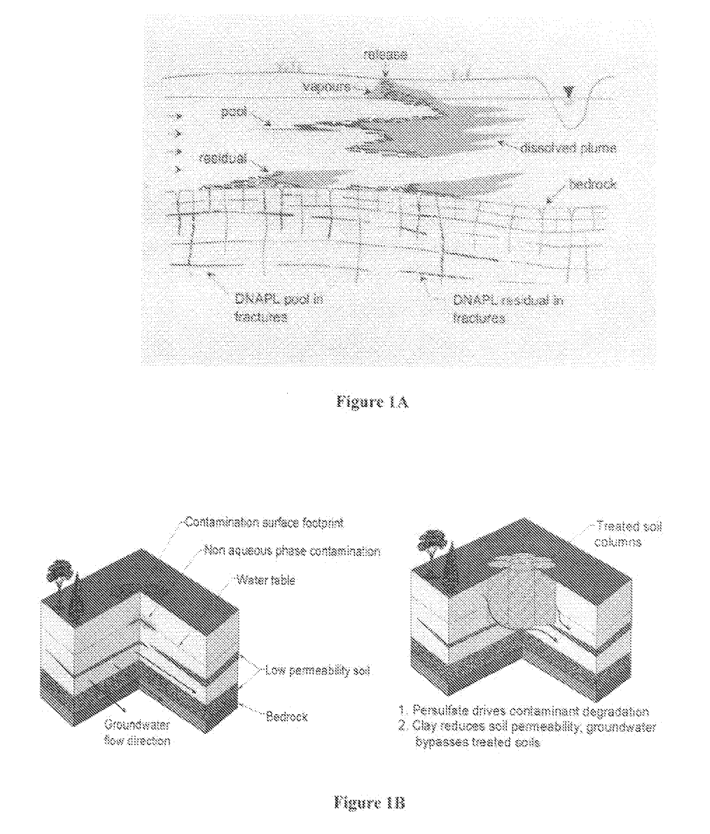

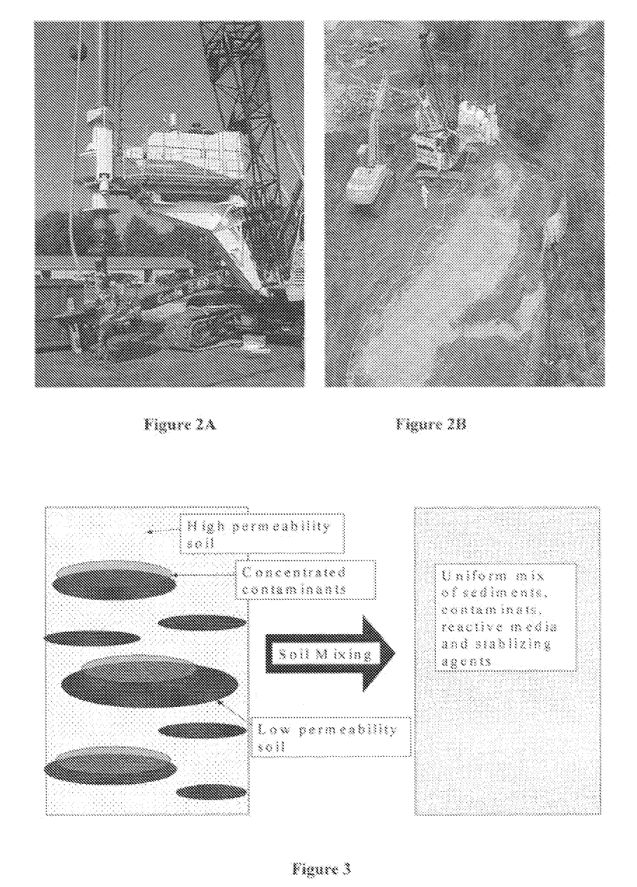

### DETAILED DESCRIPTION OF EMBODIMENTS OF THE INVENTION

The present invention includes a novel method for treating contaminants present in subsurface source zones. The method of the invention is comprised of admixing chemical oxidants and stabilizing agents with source zone materials using in situ soil-mixing techniques. The primary intended benefits of the stabilizing agent include reduction of contaminant discharge from the source, extended periods for treatment to occur, reduced inflow of naturally occurring oxidizing or reducing agents that might interfere with the desired reactions, facilitation of mixing, and delivery of remedial agents. The method of the present invention relies on the chemical oxidation of the subsurface zone contaminants.

Various terms are used herein to refer to aspects of the present invention. To aid in the clarification of the description of the components of this invention, the following definitions are provided.

It is to be noted that the term “a” or “an” entity refers to one or more of that entity. As such, the terms “a” or “an,” “one or more” and “at least one” are used interchangeably herein.

The term “subsurface source zone” or “source zone” as used herein refers to a saturated or unsaturated subsurface zone containing hazardous substances, pollutants, or contaminants that acts as a reservoir that sustains a contaminant plume in groundwater, surface water, or air or acts as a source for direct exposure. This volume may have been in contact with separate phase contaminant (Nonaqueous Phase Liquid [NAPL] or solid). Source zone mass can include sorbed and aqueous-phase contaminants as well as contaminants that exist as a solid or NAPL.

The term “chemical oxidant” as used herein refers to any additive that promotes chemical oxidation of source zone contaminants. Chemical oxidants are chemical electron acceptors. Chemical oxidants specifically do not include chemical reductants such as zero valent iron. Chemical oxidants specifically do not include metallic couples, ferrous iron, alkali metal sulfides or polysulfides, alkali or alkaline earth metal carbonate, bicarbonate or hydroxide. Chemical oxidants do include, but are not limited to, electron acceptors such as permanganate, persulfate, ozone and peroxide.

The term “stabilizing agent” as used herein refers to substances that reduce the hydraulic conductivity of the treated source zone with intended benefits including, but not limited to one or more of the following: reducing contaminant discharge from the source, providing extended periods for treatment to occur, retaining chemical oxidants in the target source zone, and limiting the inflow of naturally occurring oxidizing or reducing agents that might interfere with the desired reactions. Stabilizing agents also facilitate drilling and delivery of remedial agents. Examples of stabilizing agents include, but are not limited to clays such as kaolinite and bentonite, cement plant kiln dust, fly ash, Portland cement, soluble silicate-cement, pozzolan-lime, and clay cement.

The term “contaminant” or “hazardous substance” or “pollutant” as used herein refers to any undesirable occurring chemical substance or naturally occurring substance present at unusually high concentrations. Examples of contaminants include, but are not limited to volatile organic compounds (including benzene toluene, ethylenzene and xylene), halogenated volatile organic compounds (including tetrachloroethene, trichloroethene, carbon tetrachloride, chloroform, and trichloroethane), petroleum hydrocarbons, semi-volatile organic compounds (including napthlene, anthracene, and benzoapyrene) halogenated non-volatile organic compounds (including aldrin, dieldrin and endrin, pesticides, herbicides, inorganic compounds (including arsenic, lead and chromium), radionuclides, explosives (including, 2,4,6-trinitrotoluene, dinitrotoluene, hexahydro-1,3,5-trinitiro-1,3,5-triazine, and octahydro-1,3,5,7-tetranitro-1,3,5,7-tetrazine), emerging contaminants (including pharmaceuticals, biogenics [e.g. sterols, hormones], fire retardants, plasticizers, antioxidants and refrigerants).

The term “soil mixing” refers to any in situ soil-mixing technique known in the art. Specific examples include, but not limited to shallow soil mixing, deep soil mixing, jet grouting, mixing with conventional excavation equipment and combinations thereof. Challenges associated with heterogeneity can be addressed by employing soil-mixing techniques including, but not limited to, soil augers with grout delivery systems and conventional excavation equipment, which are illustrated in FIG. 2. The purpose of the grout is to deliver in a combination of reactive media and stabilizing agents and to facilitate drilling. Using soil mixing, high concentration contaminant layers can be dispersed such that treatment systems can address the mean rather than the peak contaminant concentrations in the treatment zone as shown in FIG. 3. Additionally, remedial agents that drive in situ chemical oxidations can be uniformly delivered to the contaminants independent of the presence of preferential flow paths. Finally, stabilizing agents including, but not limited to clays, cements, biopolymers, fly ash and combinations thereof can be added to reduce the hydraulic conductivity of the source material post-treatment. Stabilizing agents facilitate drilling and the delivery of chemical oxidants.

The term “in situ chemical oxidation” is the delivery of strong chemical oxidants to the subsurface for the purpose of treating organic contaminants.

The term “soil remediation” refers to reducing the amount of contaminants within a source zone.

The term “target area” or “target” refers to source zone, area within the source zone, or area including the source zone, where contaminant reduction or removal is sought.

The present disclosure includes a novel process for treating contaminants present in subsurface source zones comprised of admixing chemical oxidants and stabilizing agents with source materials using known soil-mixing techniques. According to one embodiment of the method of the present invention, primary benefits may include depletion of the targeted contaminants via oxidative treatment and/or adsorption on the introduced clay, reduction of the mobility of any nonaqueous phase liquids via emulsification with the colloidal clay introduced, and reduction of the hydraulic conductivity of the treated body. Additional benefits may include: a reduced discharge of target compounds to groundwater through reduced flow of groundwater through the target and a reduction in the contaminant mass in the target that can leach to groundwater, a diversion of groundwater into areas adjacent to or below the target where natural attenuation process can deplete contaminants of concern in the aqueous phase, and reduced releases of volatile target compounds to soil gas above the watertable.

The contaminants that can be treated using the method of this invention include hazardous substances, pollutants or any other undesirable non-naturally occurring chemical substances or naturally occurring substances present at unusually high concentrations. Examples of contaminants include, but are not limited to volatile organic compounds (including halogenated compounds), petroleum hydrocarbons, semi-volatile organic compounds (including halogenated compounds), non-volatile organic compounds, pesticides, herbicides, metals, radionuclides, explosives/UXO, and emerging contaminants (e.g. pharmaceuticals, biogenics [e.g. sterols, hormones], fire retardants, plasticizers, antioxidants and refrigerants) as well as combinations of any of the forgoing.

The chemical oxidants that can be used accordance with the method of the present invention include any additive that promotes chemical oxidation of source zone contaminants, including but not limited to permanganate, persulfate, ozone, peroxide and combinations thereof.

The stabilizing agents that can be used in accordance with the method of one embodiment of the present invention include any agent that limits the movement of the targeted chemical(s) and/or facilitates soil mixing and/or delivery of treatment amendments. The stabilizing agent is selected to perform any one or combination of the following functions: reducing the hydraulic conductivity of the source; producing a grout that suspends the chemical oxidant for transfer through the mixing equipment and improving delivery of chemical oxidants into the targeted source area; producing a drilling fluid with properties that facilities penetration and mixing of the targeted source; increasing post-treatment strength of the source zone sediments and reducing the mobility of the targeted contaminates through either adsorption and/or precipitation. Reducing the hydraulic conductivity of the source is important in that it results in a reduction in contaminant discharge from the source (this can be critical post mixing due to contaminant dispersion via mixing), a longer period for oxidation or stabilization reactions to proceed and a reduction in inflow agents that could inhibit the desired reactions. Specific examples of stabilizing agents include, but are not limited to clays, cements, biopolymers, fly ash and combinations thereof.

Any in situ soil-mixing technique can be used with the method of the instant invention. Specific examples include, but are not limited to shallow soil mixing, deep soil mixing, jet grouting, mixing with conventional excavation equipment and combinations thereof. In certain embodiments; the soil-mixing technique is selected to perform any one or combination of the following functions: a reduction in the need to rigorously characterize the architecture of high concentration contaminant intervals within source zones; dispersion of high concentration contaminant intervals in source zones thereby facilitating better contact between contaminant and chemical oxidant including contaminants in low permeability materials, stabilizing nonaqueous phase liquids through the formation of emulsions (e.g. pickering emulsion), accelerated dissolution of nonaqueous phase liquids by increasing surface area, reduction in high local contaminant concentrations and uniformly deliver chemical oxidants into the targeted source area independently of local soil permeability and porosity heterogeneity.

As noted above, the method described herein provides a simple and cost effective option for the effective treatment of select subsurface source zones. The method is cost effective in that it requires less treatment amendment due to the homogenization achieved through mixing of soils, contaminants, and treatment amendments.

The disclosure includes a novel process for treating contaminants present in subsurface source zones comprised of admixing chemical oxidants and stabilizing agents with source materials using known soil-mixing techniques. According to the method of the present invention the subsurface zone contaminants are either stabilized or degraded via chemical oxidation processes that are facilitated through addition of chemical oxidants and stabilizing agents. In one embodiment, the method of the present invention relies on the oxidation or stabilization of the subsurface zone contaminants by direct chemical oxidation. In other embodiments, the method of the present invention further comprises admixing a microbial inoculum(s) together with the chemical oxidants and stabilizing agents.

Note that throughout this application various citations are provided. Each of these citations is specifically incorporated herein by reference in its entirety.

### EXAMPLE 1

As an example, it is envisioned that the invention would be employed at a petroleum refining underlain by sediments that can be mixed using soil mixing equipment. As is commonly the case, it is envision that an interval of petroleum-contaminated media exists about the watertable underlying the refinery. The targeted interval is treated by admixing in about 5% by dry weight soil Kaolin clay and about 2% by dry weight soil sodium persulfate. Admixing stabilizing agents, reactive media, and target soils is achieved in situ using large diameter drilling equipment with pumps and piping for grout delivery. Grout delivery and drilling occur concurrently. Overlapping vertically mixed columns are drilling across the areal extent of the targeted material. The drilled columns are completed vertically through the interval of concern.

Primary benefits include 1) depletion of the targeted fuel hydrocarbons via oxidative treatment and/or adsorption on the introduced clay 2) reduction of the mobility of any nonaqueous phase liquids via emulsification colloid materials (e.g. introduced Kaolin), and 3) reduction of the hydraulic conductivity of the treated body. Additional benefits include 1) a reduced discharge of target compounds to groundwater through a) reduced flow of groundwater through the target and b) a reduction in the contaminant mass in the target that can leach to groundwater, 2) diversion of groundwater into areas adjacent to or below the target where natural attenuation process can deplete contaminants of concern in the aqueous phase, and 3) reduced releases of volatile target compounds to soil gas above the watertable.

### EXAMPLE 2

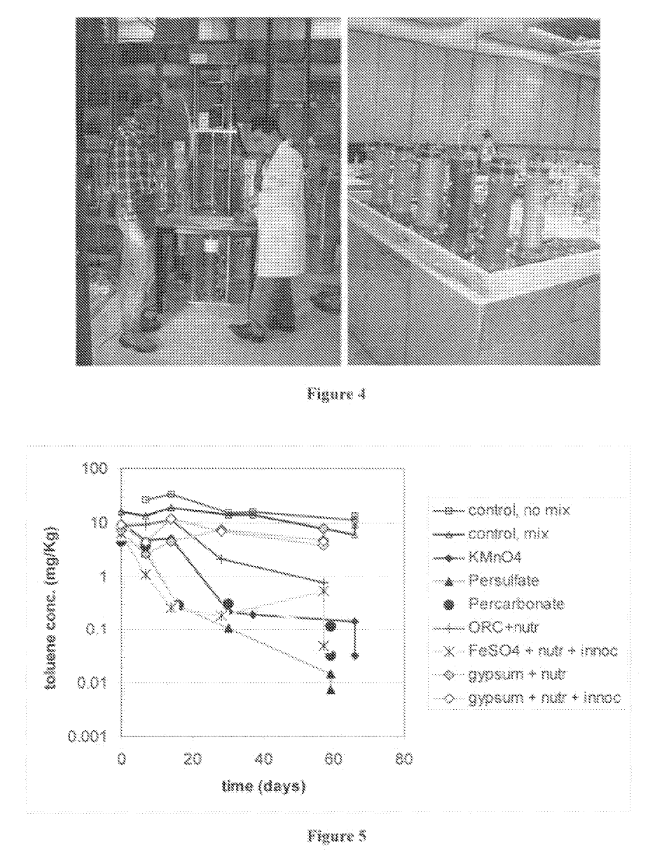

The process is further demonstrated through related laboratory and field demonstrations. Proof of concept experiments were conducted using soils from a petroleum refinery spiked with 30 mg/kg toluene, 5% by dry weight kaolin, and promising reactive media. Laboratory soils mixing equipment and treated soil columns are shown in FIG. 4. Soil samples were collected from the treated soil columns through time and analyzed for toluene. Observed toluene concentrations in soils collected from the columns as a function of time (for a variety of treatments) are presented in FIG. 5.

### EXAMPLE 3

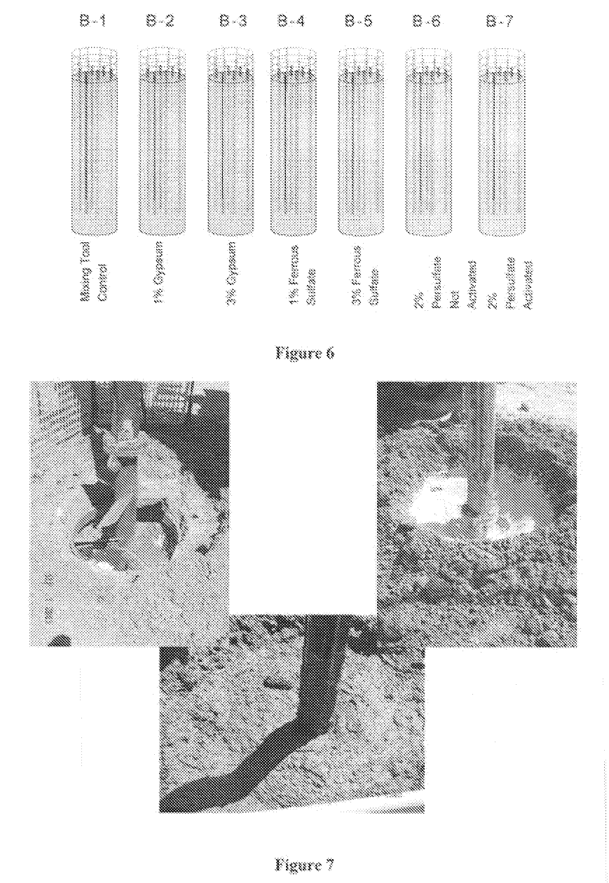

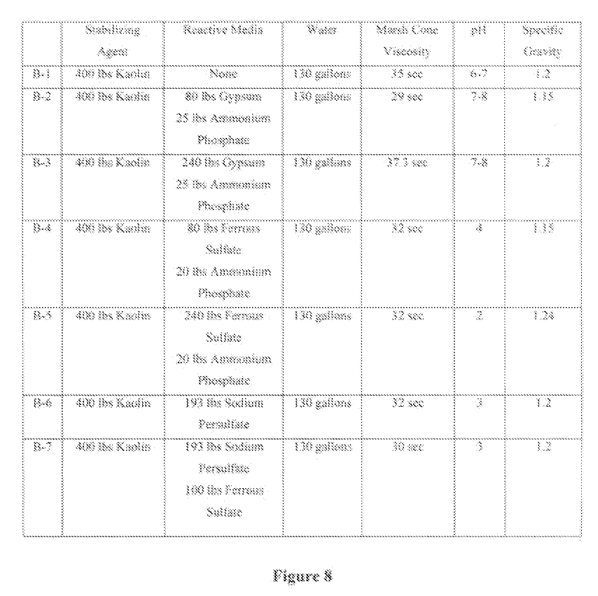

Favorable laboratory results led to a field demonstration in September 2005. The field demonstration included seven field test columns (B-1 through B-7—See FIG. 6). The study was conducted at an active refinery where fuel hydrocarbons were present about the watertable. Sediments in the targeted area range from silt to sand to gravel. Each column is 3 feet in diameter and approximately 14 feet deep. Admixing of reactive media and stabilizing agents was accomplished using a modified Watson drill rig (typically used for completion of caissons). Modifications included adding a swivel to the drill kelly for delivery of the grout and fabrication of a 3-foot diameter soil mixing tool. FIG. 7 depicts initial drilling (upper left), initial grout delivery (upper right), and subsequent soil mixing (lower center).

The grout was mixed using a 150-gallon cement mixer, a diaphragm pump, and 750-gallon galvanized steel water tank. The composition of the grout developed for each treatment is presented in FIG. 8. The basis for the clay amount was to produce 1) a grout with sufficient viscosity to suspend granular reactive media, 2) a suitable drilling fluid, and 3) a post treatment in situ hydraulic conductivity less than 1×10⁻⁷ cm/sec. The basis for the amount of persulfate was provision of excess of reactive media for the targeted contaminant mass. Most of the grout was injected on the first downward pass through the targeted vertical interval. Subsequently, the drill tool was raised and lowered through the targeted interval 6 to 8 times. Multiple passes were employed to achieve a uniform mixture of contaminant, reactive media, and stabilizing agents. The rate of rise and decent of the mixing tool was approximately 1-5 feet per minute. The rate of rotation of the drill tool ranged from ˜10 to 100 revolutions per minute.

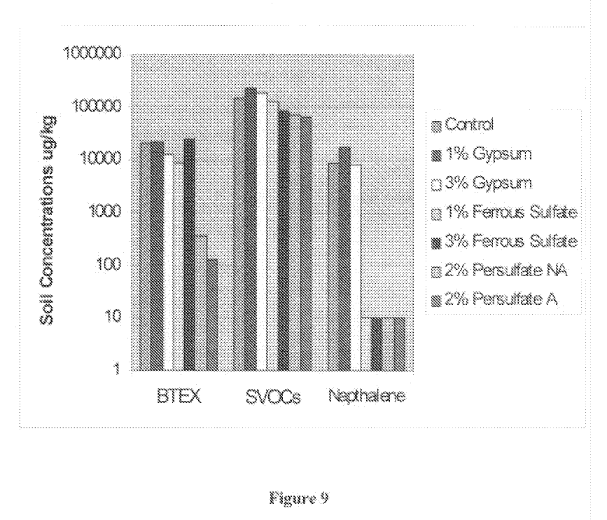

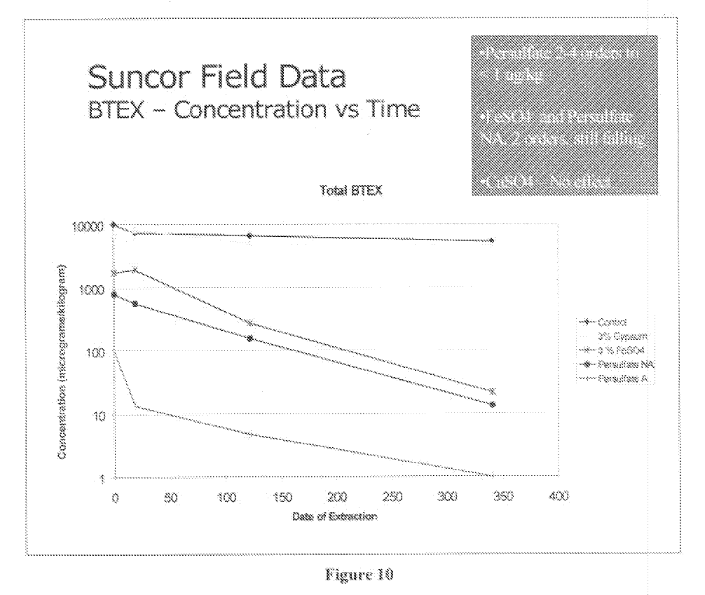

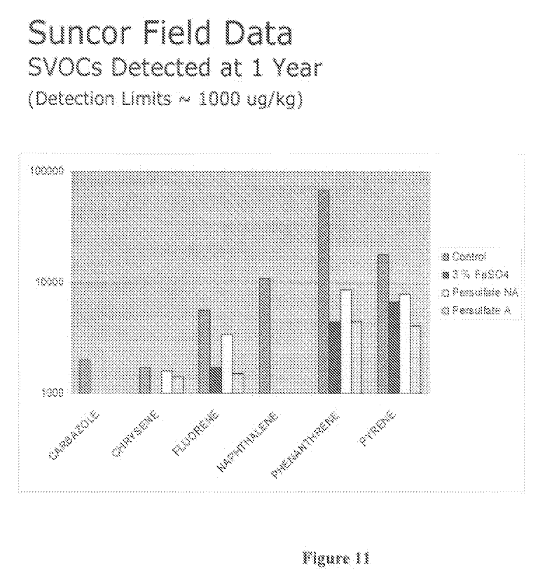

Four months after treatment soil samples were collected from each of the seven test columns and analyzed for total volatile organic compounds and semi-volatile compounds. Results presented in FIG. 9 indicate that (relative to the control) the persulfate treatment reduced 1) total Benzene, Toluene, Ethylbenzene, and Xylene (BTEX), 2) total semi-volatile compounds (SVOC) by a factor greater than two and 3) naphthalene by three orders of magnitude.

Results from the first year on monitoring are presented in FIG. 10 and FIG. 11. Using the control as the baseline, removal of BTEX ranges from ˜0% (gypsum) to ˜99.99% (activated persulfate). Demonstrated removal of polyaromatic hydrocarbons (PAHs) is dependent of on the specific compounds. The most promising result of >99% was achieved with naphthalene.

### EXAMPLE 4

In addition, laboratory studies have been conducted to demonstrate the formation of stable nonaqueous phase liquid (NAPL) emulsions by mixing NAPL with stabilizing agents. Vials contained kaolin clay, water, and perchloroethene (PCE) with red dye. Initial mixing formed the observed emulsion. Six months the emulsified drops had not coalesced. The process involves 1) colloidal particles reducing the interfacial tension at the water NAPL interface and 2) the high viscosity do the water clay mixture precluding coalescing of the NAPL droplets. Emulsification of NAPL has two benefits including precluding NAPL migration and increasing the surface area for dissolution of the targeted contaminant into the aqueous phase where, it can be degraded.

### EXAMPLE 5

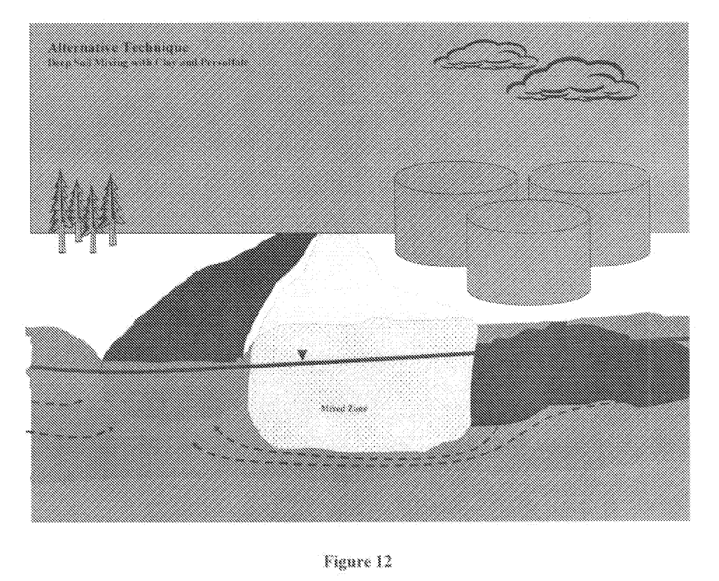

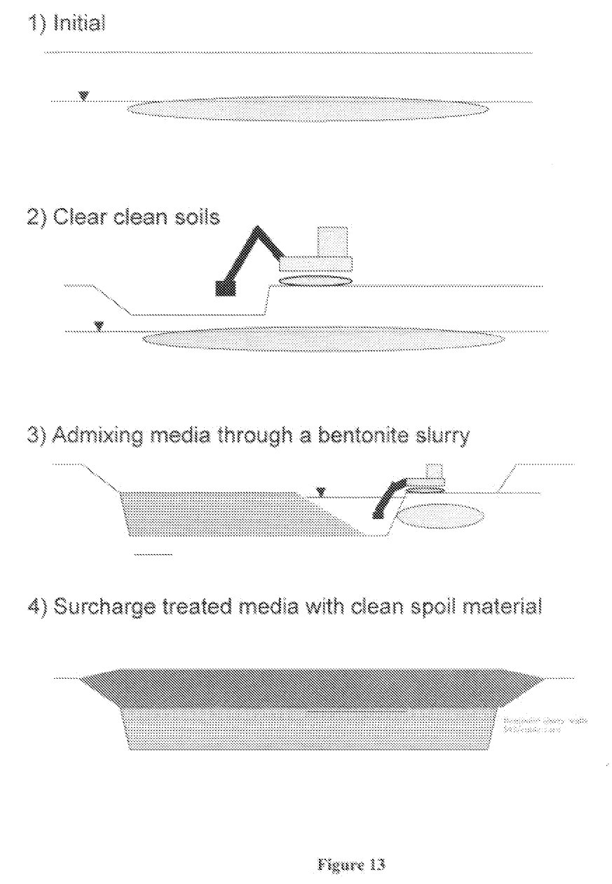

Another embodiment of the invention includes the application of persulfate-clay. The concept is illustrated in FIG. 12. As depicted, an NAPL smear zone along a 300-foot band adjacent to a river is treated with persulfate and clay. The low permeability of the treated material will deflect groundwater flow downward where dissolved phase hydrocarbons (from upgradient dissolution of NAPL) will have sufficient time to attenuate naturally before reaching the river. As illustrated in FIG. 13, process steps include the removal of clean soils down to a level 2-4 feet above the LNAPL smear zone; the In situ mixing of impacted soil with 2% persulfate and 2% clay bentonite clay using a backhoe; cover of the treated media with clean fill as a surcharge to accelerate consolidation of treated media; and post treatment monitoring.

What is claimed is:

1. A method for soil remediation comprising
a. admixing a chemical oxidant,
b. admixing a stabilizing agent, and
c. employing in situ soil mixing.

2. The method of claim 1 wherein the contaminants in the treated soil are diminished.

3. The method of claim 1 wherein the chemical oxidant is selected from the group consisting of permanganate, persulfate, ozone, peroxide and combinations thereof.

4. The method claim 1 wherein the stabilizing agent is selected from the group consisting of clay, cement, biopolymer, fly ash and combinations thereof.

5. The method of claim 1 wherein said in situ soil mixing is selected from the group consisting of shallow soil mixing, deep soil mixing, jet grouting, mixing with conventional excavation equipment and combinations thereof.

6. The method of claim 2 wherein said contaminants in the soil are selected from the group consisting of one or more of petroleum hydrocarbons, volatile organic compounds, volatile organic halogenated compounds, semi-volatile organic compounds, semi-volatile organic halogenated compounds, non-volatile organic compounds, pesticides, herbicides, metals, radionuclides, explosives, and emerging contaminants.

7. The method of claim 1 wherein said in situ the soil mixing uniformly delivers said chemical oxidants.

8. The method of claim 1 wherein said stabilizing agent reduces contaminant discharge from said treated area.

9. The method of claim 1 wherein said stabilizing agent reduces inflow of naturally occurring oxidizing or reducing agents into said treated area.

10. The method of claim 1 wherein said chemical oxidant is persulfate and said stabilizing agent is clay.

11. The method of claim 9 wherein said treated area is adjacent to a water source.

12. The method of claim 10 wherein said water source is a river.

13. A method for treating contaminants present in subsurface source zones comprising in situ soil mixing comprising admixing a chemical oxidant, a stabilizing agent and source materials.

14. The method of claim 13 wherein the chemical oxidant is selected from the group consisting of permanganate, persulfate, ozone, peroxide and combinations thereof.

15. The method claim 13 wherein the stabilizing agent is selected from the group consisting of clay, cement, biopolymer, fly ash and combinations thereof.

16. The method of claim 13 wherein said in situ soil mixing is selected from the group consisting of shallow soil mixing, deep soil mixing, jet grouting, mixing with conventional excavation equipment and combinations thereof.

17. The method of claim 13 wherein said source materials are selected from the group consisting of one or more of petroleum hydrocarbons, volatile organic compounds, volatile organic halogenated compounds, semi-volatile organic compounds, semi-volatile organic halogenated compounds, non-volatile organic compounds, pesticides, herbicides, metals, radionuclides, explosives, and emerging contaminants.

18. The method of claim 13 wherein said in situ soil mixing stabilizes the nonaqueous phase liquids through the formation of emulsions.

19. The method of claim 13 wherein said in situ the soil mixing uniformly delivers said chemical oxidants.

20. The method of claim 13 wherein said stabilizing agent reduces contaminant discharge from said source materials.

21. The method of claim 13 wherein said stabilizing agent reduces inflow of naturally occurring oxidizing or reducing agents.

22. A grout for remediation of contaminated soils comprising:
a. a stabilizing agent; and
b. a chemical oxidant.

23. The method of claim 22 wherein the chemical oxidant is selected from the group consisting of permanganate, persulfate, ozone, peroxide and combinations thereof.

24. The method claim 22 wherein the stabilizing agent is selected from the group consisting of clay, cement, biopolymer, fly ash and combinations thereof.
